(19) United States
(12) Patent Application Publication
(10) Pub. No.: US 2021/0140809 A1
(43) Pub. Date: May 13, 2021

(54) SYSTEM AND METHOD FOR MONITORING LEVEL OF MATERIAL STORED IN RECEPTACLES

(71) Applicant: INVENTROM PRIVATE LIMITED, MERCES, NORTH GOA (IN)

(72) Inventors: PRANAV PAI VERNEKAR, MERCES, NORTH GOA (IN); DHEERAJ GADKAR, GHULBARGA (IN); PRANAV KUNDAIKAR, PANJIM (IN); DATTAPRASAD NAIK, TALEIGAO PANAJI (IN); RAHUL KUMAR, DISTRICT VARANASI (IN); SOURABH TIWARI, DISTRICT VARANASI (IN)

(21) Appl. No.: 16/618,415

(22) PCT Filed: May 31, 2018
(86) PCT No.: PCT/IB2018/053879

§ 371 Date: Jul. 4, 2020

(30) Foreign Application Priority Data
Jun. 2, 2017 (IN) 201721019483

(51) Int. Cl. G01F 23/00; B01L 3/00

(52) U.S. Cl. CPC G01F 23/0076; B01L 3/508; B01L 2300/024; B01L 2300/028; B01L 2300/023; B01L 2300/0663

(57) ABSTRACT

A container to monitor a predefined level or to determine the density or viscosity of a medium associated with an object under measurement in the container. The container includes a plurality of sensors adapted to sense, in real time, a level of the object inside the container. In addition, one or more processors retrieve, in real time, the sensed level or the one or more sensed properties. The one or more processors determine, in real time, based on the sensed level or the one or more sensed properties, a current level of the object inside the container, or one or more current properties associated with the object inside the container.

### TECHNICAL FIELD

The present disclosures relate to receptacles, more specifically, to receptacles, such as but not limited to, containers or vessels or reservoirs, that store material such as solid, liquid, gas, or plasma. In particular, the present disclosure pertains to an Internet of Things (TOT) based system and method for monitoring level of materials stored in the receptacles.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Human beings have used receptacles (also interchangeably used hereinafter as containers or vessels or reservoirs) for at least 100,000 years, and possibly for millions of years. The first receptacles were probably invented for storage of food and/or liquid, allowing the food to be preserve for a longer time. Receptacles thereafter are continued to be developed along with related advances in human technology and development of new materials and new means of manufacture. Receptacles units form an integral part of entire food industry, oil industry, shipping industry, and transport industry.

In recent years, various players in the oil industry and the food industry have tried to develop receptacles that can monitor consumption of materials such as liquids, vegetable oils and food as the consumption of said materials in a domestic environment as well as in commercial industry may be challenging in busy routine of our day-to-day life. For example, monitoring calorie consumption on basis of oil usage is a challenging task for a person. Accordingly, if consumption is not carefully monitored in a domestic environment and commercial industry, health benefit and revenue associated therewith may be potentially negatively impacted.

Efforts have been made in related art to address above stated problem by providing a monitoring device to track consumption of material such as liquids, vegetable oils and food stored in a receptacle. For example, United State Patent US 20120259180 A1 discloses a hydration monitoring device that automatically tracks consumption of liquid from a bottle through periodic mass measurements of the bottle. More specifically, the hydration system provides an improved reservoir and delivery system that is integrated with a computerized nutritional calculator (CNC) that monitors real-time expenditure and consumption of nutrition.

In spite of various available prior-art techniques in the field of smart containers and monitoring mechanisms associated therewith, the present technologies majorly include a process of data collection, using sensors, locally on a chip and have limitations such as less storage space, and inability to support multiple channels to fetch collected data and then represent the data. Further, most of the existing monitoring mechanisms are built for measuring very large volumes, it is often a challenge to report the collected data to cloud servers or data acquisition systems for monitoring and tracking.

Whereas there is certainly nothing wrong with existing techniques smart containers and monitoring mechanisms, nonetheless, there still exists a need to provide an efficient, effective and reliable monitoring mechanism that not only monitors level of material stored in large receptacles but is also capable of monitoring the level of materials stored in small containers.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

It is a general object of the present disclosure to provide a system and method for monitoring level of material stored in small and large receptacles using Internet of Things (IOT) devices.

It is another object of the present disclosure to provide a system and method for collecting information associated with level of the material stored in receptacles, determining the level of the material based on collected information, and displaying information associated with the level the material.

It is yet another object of the present disclosure to provide a system and method for collecting information associated with level of the material in receptacles and transmitting the collecting information to remotely located devices and/or cloud server for remote monitoring.

It is still another object of the present disclosure to provide a system and method for collecting information associated with level of the material, compute usage of the material based on the level determined, and representing the usage in user friendly and user understandable manner on a display of a user device.

### SUMMARY

The present disclosures relate to receptacles, more specifically, to receptacles, such as but not limited to, containers or vessels or reservoirs, that store material such as solid, liquid, gas, or plasma. In particular, the present disclosure pertains to an Internet of Things (TOT) based system and method for monitoring level of materials stored in the receptacles.

Technical problems to be solved in the present invention are that: currently, the present technologies majorly include a process of data collection, using sensors, locally on a chip and have limitations such as less storage space, and inability to support multiple channels to fetch collected data and then represent the data. Second, known prior-art system or monitoring mechanisms are built for measuring very large volumes, it is often a challenge to report the collected data to cloud servers or data acquisition systems for monitoring and tracking.

To solve the above recited and other available technical problems in the prior-art, the present invention provides the following solution:

This invention provides a new, efficient, improved and technically advanced monitoring mechanism that not only monitors level of material stored in large receptacles but is also capable of monitoring the level of materials stored in small containers.

Embodiments of the present disclosure provide an efficient, effective, reliable, improved monitoring mechanism. Further, The present disclosure relates to receptacles, more specifically, to receptacles, such as but not limited to, containers or vessels or reservoirs, that store material such as solid, liquid, gas, or plasma. In particular, the present disclosure pertains to an Internet of Things (TOT) based system and method for monitoring level of materials stored in the receptacles.

Accordingly, an aspect of the present disclosure relates to a container for monitoring a predefined level or to determine the density or viscosity of a medium associated with an object (also interchangeable referred to as “material” for example any, solid, liquid or gaseous material) under measurement in said container. In an aspect, the container can include a plurality of sensors and a processor.

In an aspect, the plurality of sensors can be adapted to sense, in real-time, at least a level of said object inside said container or properties associated with said object inside said container.

In an aspect, the processor can retrieve, in real-time, at least said sensed level or said one or more sensed properties. In another aspect, the processor can determine, in real-time, based on said sensed level or said one or more sensed properties, a current level of said object inside said container, or one or more current properties associated with said object inside said container.

In an aspect, the container can include a transceiver, communicably coupled to said one or more processors, wherein said one or more processors causes the transceiver to transmit said retrieved sensed level or said retrieved one or more sensed properties to one or more devices located at remote location.

In an aspect, the container can include a Global System for Mobile communications (GSM) system, communicably coupled to said one or more processors, wherein said one or more processors causes the GSM system to transmit said retrieved sensed level or said retrieved one or more sensed properties to one or more devices located at remote location.

In an aspect, retrieved sensed level or said retrieved one or more sensed properties can be analyzed to generate a report associated with at least one pre-configured parameter of said object inside said container, wherein said report is an visual representation of said at least one pre-configured parameter.

In an aspect, container can include an operable switch, preferably at a bottom of said container, to enable power supply from a pre-determined power source to said plurality of sensors and said one or more processors for operations.

In an aspect, the container can include a display communicably coupled to one or more processors. The one or more processors can cause the display to indicate one or more properties associated with said object inside said container, changes in level of said object inside said container, based on said sensed level or said one or more sensed properties at least a current level of said object inside said container. The one or more properties can be indicated on one or more user configurable screens.

In an aspect, the container can include a plurality of indicators communicably coupled to one or more processors. One or more processors can cause at least one indicator selected from said plurality of indicators to indicate, based on said sensed level or said one or more sensed properties at least a current level of said object inside said container, one or more properties associated with said object inside said container, changes in level of said object inside said container.

In an aspect, plurality of sensors can be selected from any or any combination of a pressure sensor, a strain gauge (weight gauge) sensor, a level sensor, an electronic sensor, an ultrasonic liquid-level sensor, a temperature sensor, a viscosity sensor, a density sensor, an multi-axis accelerometer, and a multivariable sensor.

In an aspect, the container is a container in which said object is packaged or a container in which a packaged object is poured before usage.

In an aspect, the plurality of sensors can include one or more pressure sensors to measure a pressure inside said container in real-time and communicate the measured pressure to said one or more processors to determine a height of the object in said container is proportionate to the measured pressure. In another aspect, the plurality of sensors can include one or more weight gauge sensors to measure, a volume inside said container in real-time and communicate the measured pressure to said one or more processors to determine a quantity of the object currently present in said container.

An aspect of the present disclosure relates to a method for monitoring a predefined level or for determining the density or viscosity of a medium associated with an object under measurement in a container. The method can include the steps of: sensing, at a plurality of sensors embedded in said container, in real-time, at least a level of said object inside said container or properties associated with said object inside said container; retrieving, at one or more processors embedded in said container, in real-time, at least said sensed level or said one or more sensed properties; determining, at said one or more processors in real-time, based on said sensed level or said one or more sensed properties, a current level of said object inside said container, or one or more current properties associated with said object inside said container; and transmitting, by said one or more processors, in real-time said retrieved sensed level or said retrieved one or more sensed properties to one or more devices located at remote location, wherein said container comprises an operable switch, preferably at a bottom of said container, to enable power supply from a pre-determined power source to said plurality of sensors and said one or more processors for operations.

In contrast to the conventional system, the present disclosure provides a new, efficient, and technically advanced and improved monitoring mechanism that not only monitors level of material stored in large receptacles but is also capable of monitoring the level of materials stored in small containers. Further, in contrast to the conventional system, the present disclosure provides an Internet of Things (TOT) based system and method for monitoring level of materials stored in the receptacles.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates network architecture for monitoring level of material in receptacle in accordance with an exemplary embodiment of the present disclosure.

FIG. 2 illustrates an exemplary block diagram of the proposed monitoring device in accordance with embodiments of the present disclosure.

FIGS. 3A and 3B illustrates exemplary representation of data obtained based on information associated with level of material stored in the receptacle in accordance with embodiments of the present disclosure.

FIG. 4 illustrates exemplary functional modules of a proposed monitoring device in accordance with embodiments of the present disclosure.

FIG. 5 illustrates an exemplary working of the proposed monitoring device in accordance with embodiments of the present disclosure.

FIG. 6 illustrates an exemplary flow diagram of the present system, in accordance with an embodiment of the present disclosure.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although, the present disclosure has been described for monitoring material level in small and large receptacles using Internet of Things (IOT) devices. It should be appreciated that the same has been done merely to illustrate the disclosure in an exemplary manner and any other purpose or function for which they explained structure or configuration can be used is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any electronic code generator shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Various terms as used herein are shown below. To the extent a term used in a claim is not defined below, it should be given the broadest definition persons in the pertinent art have given that term as reflected in printed publications and issued patents at the time of filing.

Aspects of the present disclosure relates to receptacles, more specifically, to receptacles, such as but not limited to, containers or vessels or reservoirs, that store material such as solid, liquid, gas, or plasma. In particular, the present disclosure pertains to an Internet of Things (TOT) based system and method for monitoring level of materials stored in receptacles. Although aspects of the present disclosure have been explained with respect to containers, such containers may be smart containers, and therefore any type/form of containers falls completely within the scope of the present disclosure.

Accordingly, an aspect of the present disclosure relates to a system having a monitoring device operatively coupled with one or more smart receptacles (also interchangeably used hereinafter as containers or vessels or reservoirs) for monitoring level of material stored in the receptacle. In an aspect, said one or more smart receptacles can include one or more sensors configured to sense/detect level information of the material stored in the receptacle. In an exemplary embodiment, the sensors can include, but is not limited to, a pressure sensor, a strain gauge sensor, a weight sensor, and the like.

In an aspect, the sensor can be located/provided/installed in the liquid, on the bottle/container cap, in the form of nozzle to measure flow or light radiation. It would be appreciated that, the installation location of the sensor is not only limited to the bottom of the container but can be installed anywhere inside/on the body to determine the level of material.

In an aspect, the level information sensed/detected by the sensor is communicated to the monitoring device for computing the level/usage of the material.

In an aspect, the monitoring device can include a microcontroller, a transmitter, a display, and a level indicator. In an aspect, the microcontroller of the monitoring device can receive the sensed/detected level information of the material stored in the container and process the level information to obtain current level of the material stored in the container. It may be appreciated by a person skilled in the art that the components such as a microcontroller, a transmitter, a display, and a level indicator that constitute to form a monitoring device can also be part of the smart containers and need not be always provided in the form of a monitoring device.

In an aspect, the monitoring device is configured with a battery to provide electrical power to various components of the monitoring device so as to ensure proper and efficient functioning of various components of the monitoring device. In another aspect, the battery can be operatively coupled to the smart container. In another aspect, the monitoring device is adapted to receive a direct current from an internal and/or external source of power supply.

In an aspect, the current level of the material stored in the container obtained by the microcontroller can be transmitted, using the transmitter, to a remote device/database/cloud server for storage and/or tracking usage of the material stored in the container. In an exemplary aspect, the transmitter can be a Wi-Fi based chip or a GSM based chip or Bluetooth. In another exemplary aspect, the transmitter can be activated/utilized/triggered only when a change in the level of the material stored in the container is detected by the microcontroller in order to preserve battery life of the monitoring device.

In another aspect, the current level of the material stored in the container obtained by the microcontroller can be transmitted using a Bluetooth module. In an example, the Bluetooth module can be connected to a mobile phone which is further connected to a remote device/database/cloud server for storage and/or tracking usage of the material stored in the container. In another example, the Bluetooth module can be connected directly to a remote device/database/cloud server for storage and/or tracking usage of the material stored in the container.

In an aspect, the current level and/or the level information of the material stored in the container obtained by the microcontroller can be displayed on the display of the monitoring device or on a display associated with the smart container.

In an aspect, the monitoring device can be provided with a level indicator that includes a plurality of LEDs or alarm mechanisms. The level indicator including a plurality of LEDs is provided mainly to guide user about the level of the material.

In an aspect, the monitoring device can be operational only when the material is present inside the container. In order to achieve this proper functionality of the monitoring device, a switch is provided at bottom of the smart container which is configured to get pressed only when the material is present inside the container. Upon pressing of the switch, the monitoring device is operational and computes the level/usage of the material.

In an aspect, the measured level associated with the material stored in the container and/or the data stored at the remote device/database/cloud server for storage and/or tracking usage of the material stored in the container can be utilized for predicting the usage/consumption of the material for next or future days or months. In an example, the future predictions can help the users to plan out future purchase, calorie consumption and also make him more n more health conscious.

An aspect of the present disclosure relates to a smart container having a sensor, a microcontroller, a transmitter, a display, and a level indicator. In an aspect, the data associated with the level of the material can be collected by microcontroller in a fixed time interval and stored locally in a memory of the microcontroller. Whenever the microcontroller detects a change in level of material, the microcontroller triggers the transmitter and sends the data to a cloud server/server/database. The change can be detected by comparing current value of the level of the material read by the sensor to the last value of the level of the material stored in the memory of the microcontroller. If a change in level of the material is detected, the microcontroller transmits the data to cloud server. The transmitter is only switched on when a change in the level of the material is observed to preserve battery life of the monitoring device.

FIG. 1 illustrates network architecture for monitoring level of material in a receptacle in accordance with an exemplary embodiment of the present disclosure. It would be appreciated that aspects of the present disclosure can be applied to a variety of network architectures, all of which are well within the scope of the present disclosure.

In an aspect, network architecture of the present disclosure can include a plurality of network devices such as transmitter, receivers, and/or transceivers that may include one or more Internet of Things (IOT) devices. As used herein, an IOT device can be a device that includes sensing and/or control functionality as well as a Wi-Fi transceiver radio or interface, a Bluetooth transceiver radio or interface, a ZigBee transceiver radio or interface, an Ultra-Wideband (UWB) transceiver radio or interface, a Wi-Fi Direct transceiver radio or interface, a Bluetooth Low Energy (BLE) transceiver radio or interface, and/or any other wireless network transceiver radio or interface that allows the IOT device to communicate with a wide area network and with one or more other devices. In some embodiments, an IOT device may include a cellular transceiver radio, and may be configured to communicate with a cellular network using cellular network transceiver radio. IOT devices may include home automation network devices that allow a user to access, control, and/or configure various home appliances located within user's home (e.g., a television, radio, light, fan, humidifier, sensor, microwave, iron, and/or the like), or outside of the user's home (e.g., exterior motion sensors, exterior lighting, garage door openers, sprinkler systems, or the like). Network device may include a home automation switch that may be coupled with a home appliance. In some embodiments, network devices may be used in other environments, such as a business, a school, an establishment, a park, or any place that can support a local area network to enable communication with network devices. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a computing device, a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

In an embodiment, FIG. 1 illustrates a monitoring device 106 connected to a receptacle 102 (also interchangeably used hereinafter as container or vessel or reservoir) for monitoring level of material stored in small and large containers using IOT devices, which is further coupled with a cloud server/database/remoter monitoring system/data acquisition system 110.

In an exemplary embodiment, receptacle 102 can be an IOT enabled container 102, i.e., the receptacle 102 can be a container 102. The container 102 can include one or more sensors 104 to sense/detect level of material in the container 102. In an exemplary embodiment, the sensors 104 can include, but is not limited to, a pressure sensor, a strain gauge sensor, a weight sensor, and the like.

In an exemplary embodiment, the monitoring device 106 can be pre-installed/pre-connected/pre-fitted to the container 102 at the time of manufacturing of the container 102 or can be installed/connected/fitted to a conventional container.

In an embodiment, a monitoring device 106 monitors level of material in container 102. The container 102 can include one or more sensors 104 pre-installed or installed on a conventional container. Examples of sensors that are to be used herein may include, but are not limited to, a pressure sensor or a strain gauge sensor.

In an exemplary implementation, sensors 104 are adapted to communicate level information associated with material in container 102 to monitoring device 106 for determining exact level of the material. In another exemplary implementation, the level of the material determined by the sensors 104 can be transmitted to a remote device/database/cloud server 110 for storage and/or tracking usage of the material stored in the container 102.

In an exemplary implementation, monitoring device 106 collects pressure or weight gauge sensor data in real time and sends it over to the cloud server 110 using internet connection by a GSM module or a Wi-Fi module or a Bluetooth module for further analysis.

Although the present subject matter is explained considering that monitoring device 106 is implemented as a device, it may be understood that the monitoring device 106 may also be implemented in a variety of computing systems, such as a laptop computer, a desktop computer, a notebook, a workstation, a mainframe computer, a server, a network server, and the like. It will be understood that the storage resource monitoring device 106 may be accessed by multiple users through one or more user devices (not shown), collectively referred to as user hereinafter, or applications residing on the user devices. Examples of the user devices may include, but are not limited to, a portable computer, a personal digital assistant, a handheld device, and a workstation. The monitoring device 106 is communicatively coupled to the container 102 which is further communicatively coupled to a data acquisition system/sever/database/cloud server 110 through a network 108.

In one implementation, the network 108 may be a wireless network, a wired network or a combination thereof. The network 108 can be implemented as one of different types of networks, such as intranet, local area network (LAN), wide area network (WAN), internet, and the like. The network 108 may either be a dedicated network or a shared network. The shared network represents an association of different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

FIG. 2 illustrates an exemplary block diagram of the proposed monitoring device 106 in accordance with embodiments of the present disclosure. Referring now to FIG. 2, monitoring device 106 is illustrated in accordance with embodiments of the present subject matter. In one embodiment, the monitoring device 106 can include at least one processor/microcontroller 202, a transmitter 204, an input/output (I/O) interface/display 206, an indicator 208, a button/switch 210, a battery 212, and a memory (not shown). The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory.

The transmitter 204 can be radio transmitter which generates a radio frequency alternating current. A transmitter can be a separate piece of electronic equipment, or an electrical circuit within another electronic device. The information can be provided to the transmitter 204, preferably by the microcontroller 202, in form of an electronic signal, such as an audio (sound) signal from a microphone, a video (TV) signal from a video camera, or in wireless networking devices a digital signal from a computer. The transmitter 204 combines the information signal to be carried with radio frequency signal which generates radio waves, which is called carrier signal.

The I/O interface 206 may include a variety of software and hardware interfaces, for example, a web interface, a graphical user interface, and the like. The I/O interface 206 may allow the monitoring device 106 to interact with a user directly or through user devices. Further, the I/O interface 206 may enable the monitoring device 106 to communicate with other computing devices, such as web servers and external data servers (not shown). The I/O interface 206 can facilitate multiple communications within a wide variety of networks and protocol types, including wired networks, for example, LAN, cable, etc., and wireless networks, such as WLAN, cellular, or satellite. The I/O interface 206 can include one or more ports for connecting a number of devices to one another or to another server.

The memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The indicator 208 can be used as status indicators. In an example, the indicator 208 can be provided in the form of light-emitting diodes (LEDs) or alarms. In an exemplary embodiment the indicator can be used to indicate level of material.

The battery 212 can be a device consisting of one or more cells, in which chemical energy is converted into electricity and used as a source of power, and can be a source of energy provided to power electrical devices of monitoring device 106 such as microcontroller 202, display 206, indicators 208 and the like. In an exemplary embodiment, the battery 212 can be operated using solar energy or any other available energy suitable to operate as source of energy. In an embodiment, the monitoring device 106 is adapted to receive a direct current from an internal and/or external source of power supply.

In an embodiment, the monitoring device 106 can be coupled with one or more other sensors 104 to receive information associated with the level of the material. The sensors 104 can be coupled with the container 102. The sensors 104 can be of any available type, preferably a pressure sensor or a strain gauge sensor, capable of sensing/detecting the material associated information.

In an implementation, in case of pressure sensor, the sensor 104 measures the pressure and sends it to the microcontroller 202 of the monitoring device 106, which is accordingly converted to volume by the microcontroller 202. Since diameter of the container 102 is fixed, height of the material such as solid, liquid, gas, or plasma in the container 102 can be obtained using the pressure sensor as the height is proportionate to the pressure. It may be appreciated that the height of the container 102 can be flexible and still the height of the material in the container 102 can be obtained.

In an implementation, in case of weight gauge sensor, weight of the material is proportionate to volume of the material and hence quantity present in container 102 can be obtained. The weight of the container 102 can be calibrated in advance and the display 206 can display current weight of the container 102 along with weight of the material stored therein.

In an embodiment, data associated with level of the material can be collected by microcontroller 202 on real-time basis or after a fixed time interval and stored locally in a memory of the microcontroller 202. Whenever the microcontroller 202 detects a change in level of material, the microcontroller 202 triggers transmitter 204 and transmits data to a cloud server/server/database 110. The change can be detected by comparing current value of level of the material read by the sensor 104 to last value of level of the material stored in the memory of the microcontroller 202. If a change is detected, the microcontroller 202 transmits the data to the cloud server 110. The transmitter 204 is only switched on when change in level of material is detected to preserve battery life of the monitoring device 106. In an implementation, the monitoring device 106 can receive a direct current from an internal and/or external source of power supply without any need of internal battery thereby saving the compartment space for holding battery.

In an implementation, the transmitter 204 can be connected with a home Wi-Fi network or any existing networks. In an example, the transmitter 204 can be a GSM based system which can send the data directly to cloud server 110 without the need for any local Wi-Fi. In another example, the transmitter 204 can be a Wi-Fi base chip which can connect with the local Wi-Fi network for transmitting data over the network 108.

In another implementation, the current level of the material stored in the container 102 obtained by the microcontroller 202 can be transmitted using a Bluetooth module. In an example, the Bluetooth module can be connected to a mobile phone which is further connected to a remote device/database/cloud server for storage and/or tracking usage of the material stored in the container. In another example, the Bluetooth module can be connected directly to a remote device/database/cloud server for storage and/or tracking usage of the material stored in the container.

In an aspect, the measured level associated with the material stored in the container 102 and/or the data stored at the remote device/database/cloud server for storage and/or tracking usage of the material stored in the container 102 can be utilized for predicting the usage/consumption of the material for next or future days or months. In an example, the future predictions can help the user to plan out future purchase, calorie consumption and also make the user more health conscious. In another example, various consumer packaged goods in liquid form may be tracked in the container 102. For instance, in a hydration tracking system the container 102 can track when users drink water from the liquid cont and container for refills of the container. The container 102, however, may be used in a variety of other applications.

In an exemplary embodiment, information associated with change in level of material when detected by the microcontroller 202 can be transmitted to a remote device/cloud server/data acquisition system/database 110 for analysis purposes. In an implementation, information can be analyzed by different representation mechanisms such as graphs, charts and the like on a web browser. In an exemplary implementation, the information associated with the level of material can be utilized at cloud server/server/database 110 to display in the form of graphs and other visual representation as shown in the FIGS. 3A and 3B.

In an embodiment, the information associated with level of material can be integrated with online grocery stores for auto-reordering of the material. In another embodiment, the user can get a notification, preferably in the form of SMS, when the material level goes below a certain pre-defined value. In an exemplary implementation, alerts generated by the monitoring device 106 are being pushed in multiple ways, in the form of SMS to the registered mobile numbers, in form of push notification in mobile applications and web applications, e-mail and/or phone call.

In an exemplary embodiment, data associated with level of the material can be collected by microcontroller 202 on real-time basis or after a fixed time interval and can be displayed on the display 206 of the monitoring device 106. In an embodiment, the display 206 can include a plurality of screens. In an implementation, the monitoring device 106 can be provided with a button or a switch 210 to change screens on the display 206 to view different information associated with the level. In an exemplary implementation, different screens on the display 206 can provide different information. In an exemplary implementation, a cloud server-based analytics and/or data visualization solution is provided for a graphical visualization of the data stored in the cloud server 110. The data can be presented in the form of graphs and charts like bar charts, line charts, scattered charts, histograms, pie charts, area charts and the like. This not only offers quicker, easier and better understanding of the data gathered but also provides actionable insights which can be used to take better and informed decisions. In an exemplary implementation, the cloud server 110 can send a set of strings to the device with converted values such as calories consumed, anti-oxidants consumed and messages (which can be a cooking tip or an advertisement).

In an exemplary aspect, a screen of the display 206 can display volume of liquid in the container 102 (in ml), last usage value, current usage value, and calories consumed (in case the liquid is oil). In another exemplary aspect, a screen of the display 206 can display liquid consumed in the last hour, last day, last week, last month, and last year, calories consumed in the last hour, last day, last week, last month, and last year (in case the liquid is oil), current usage value and anti-oxidants consumed in the last hour, last day, last week, last month, and last year (in case the liquid is oil). In another exemplary aspect, a screen of the display 206 can display a message that administrator wishes to display, wherein the message can be a cooking tip or an advertisement.

In an embodiment, the monitoring device 106 can be provided with indicators 208. In an exemplary embodiment, the indicator 208 can be provided in the form of light-emitting diodes (LEDs) or alarms. In an implementation, three LEDs, say red, blue and green, can be provided to indicate different level of a liquid in the container 102 such as the red LED indicates a liquid level below 50 ml, a blue LED indicates a liquid level below 150 ml, and a green LED indicates liquid level above 150 ml. The color of the LEDs and corresponding liquid level can be changed depending on the requirement.

In an embodiment, a container 102 having a sensor 104, a microcontroller 202, a transmitter 204, a display 206, and an indicator 208 is provided. In an implementation, data associated with the level of the material can be collected by microcontroller 202 after a fixed time interval and stored locally in a memory of the microcontroller 202. Whenever, the microcontroller 202 detects a change in the level of material on real-time basis or after a fixed time interval, the microcontroller 202 triggers the transmitter 204 and sends the data to cloud server/database 110. The change can be detected by comparing current value of the level of material read by the sensor 104 to the last value of the level of material stored in the memory of the microcontroller 202. If a change is detected, the microcontroller 202 transmits the data to the cloud server 110. The transmitter 204 is only switched on when a change in level of material is detected to preserve battery life of the monitoring device 106.

In an exemplary embodiment, the container 102 can include a small switch 210 at bottom of the container 102, wherein the switch 210 gets clicked because of weight of the container 102 when kept on a flat surface. The microcontroller 202 can initiate reading value of sensor 104 when the switch stays in ON position. After processing the value read by the sensor 104, such as comparing change in the value of the sensor 104 from previous value and considering stability of the sensor value, the microcontroller 202 triggers a transmitter 204 including, but not limited to, a Wi-Fi or a GSM chip or Bluetooth to transmit the value to a cloud server 110 for further processing. In case when the container 102 is used to store oil, the cloud server 110 can return calories consumed, anti-oxidant consumed, last oil usage and display a message (message can be a cooking tip or an advertisement which can be entered on cloud server dashboard) after conversion to the monitoring device 106 as shown in FIGS. 3A and 3B. These values are displayed immediately on the display 206 present on the container 102.

FIG. 4 illustrates exemplary functional modules of a proposed monitoring device in accordance with embodiments of the present disclosure. In an embodiment, as shown in FIG. 4, the monitoring device 106 can include a sensor information receive module 402, a material level information processing module 404, a processed material information transmission module 406, an material level indication module 408, and a screen switching module 410.

In an aspect, sensor information receive module 402 can be configured to receive sense/detect information associated with level of material stored in a container 102. The sensor information receive module 402 can receive sensor information by utilizing one or more sensors 104, such as pressure sensors and/or strain gauge sensors, connected to the containers 102. In an exemplary embodiment, the sensor information receive module 402 can be configured to determine presence of the material stored inside the container 102. The sensor information receive module 402 may be used to measure/sense pressure/weight of the material stored in the container 102.

In an aspect, material level information processing module 404 can be configured to receive the information sensed/detected by the sensor information receive module 402 and compute/process the information to determine change in the level of the material on real-time basis or after a fixed time interval in the container 102. In an exemplary embodiment, the material level information processing module 404 can be configured to detect change in value of pressure/weight sensed by sensor. The change is detected by comparing current value of pressure/weight and pre-stored/pre-defined value of pressure/weight. Upon determining any change in level, the material level information processing module 404 triggers the processed material information transmission module 406 to transmit details of the change in the level to a server/database/data acquisition system 110. In an exemplary embodiment, the processed material information transmission module 406 can be configured to transmit value sensed by the sensor information receive module 402 and/or the values obtained by the material level information processing module 404. The processed material information transmission module 406 can be used for transmitting change in weight/pressure calculated by the microcontroller 202 to the cloud server/database/remote monitoring system/data acquisition system 110.

In an aspect, material level indication module 408 can be configured to provide indication associated with current status of level of material in container 102. In an exemplary embodiment, material level indication module 408 can be used to indicate level of the material stored inside the container 102. The material level indication module 408 can be configured to indicate last usage value/consumption of material stored inside the container 102. For example, if container 102 is used for storing oil, then a plurality of LED indicators 208 can be used to indicate the level of oil for instance, a red LED indicating liquid level below 150 ml, a blue LED indicating liquid level below 250 ml, and a green LED indicating liquid level above 350 ml. The display 206 can be configured to illustrate last usage value of the oil, oil in the container, calories consumed in last month and many more.

In an aspect, screen switching module 410 can be configured to switch between different screens provided on the display 206 that show different information associated with material and/or level of the material in container 102.

FIG. 5 illustrates an exemplary working of proposed monitoring device in accordance with embodiments of the present disclosure. As shown in FIG. 5, a container 102 operatively coupled to one or more sensors 104 storing a material 502 is shown. The container 102 is communicatively coupled with a monitoring device 106. The container 102 can also include a switch 504 and a button 506 at bottom of the container 102.

As shown in FIG. 5, material 502 can be a liquid, say for example oil, stored in container 102 having a pre-defined level markings as minimum level, medium level or maximum level. It may be appreciated that, the levels are pre-defined based on quantity of liquid in the container 102. For example, if quantity of liquid is above maximum level marking, the level of liquid is considered as fully filled, if liquid level is somewhere near medium marking, the level of the liquid is considered as half filled, and if quantity of the liquid is below or near the minimum level marking, the level of liquid is considered as minimum or the container 102 is considered empty.

In an aspect, sensor 104 is provided at container 102 and can sense/detect the information associated with level of the liquid inside the container 102. In an exemplary embodiment, sensor 104 can be selected from any of pressure sensor or strain gauge sensor, or the like. The sensors 104 transmit sensed information to monitoring device 106 for detecting change in level of liquid in the container 102. For example, when liquid level in the container 102 rises above the maximum level of the container, the sensor senses/detects the same and transmits the sensed information to the monitoring device 106.

In an aspect, monitoring device 106 detects if there is any change in level of the liquid inside the container 102 and accordingly displays information associated therewith on a display 206 provided on the monitoring device 106 or screen associated with the container 102. For example, whenever, the monitoring device 106 receives sensed information about liquid level in the container 102 rise above a maximum level of the container 102, the monitoring device 106 can provide a notification to a user or administrator to stop filling the liquid in the container 102.

The monitoring device 106 can also transmit information associated with change in level of material 502 to a database/server/data acquisition system 110 for further analysis, wherein further analysis can be made by representations of the levels and usage of liquid in the container at remote locations.

In an aspect, container 102 can be provided with a switch 504 at bottom of the container 102, wherein the switch 504 gets clicked because of weight of the container 102 when the container 102 is kept on a flat surface. Microcontroller 202 of the monitoring device 106 starts reading value of sensor 104 when the switch 504 stays in ON position. After processing the readings, such as comparing change in value of the sensor 104 from previous value and considering stability of the sensor value, the microcontroller 202 triggers a transmitter 204 including, but not limited to, Wi-Fi or GSM chip or Bluetooth to send the value to cloud server 110 for further processing. In case, where the container 102 is used to store cooking oil, the cloud server 110 can transmit data regarding calories consumed, anti-oxidant consumed, last oil usage and a message (message can be a cooking tip or an advertisement which can be entered on the cloud server dashboard) to the monitoring device 106. These values can be displayed immediately on the display 206 present on the container 102. There can be multiple screens to be displayed on the display 206 and screens can be changed by using a button 506 provided on the container 102.

In an aspect, the sensor 104 can be located/provided/installed in the liquid, on the bottle/container 102 cap, in the form of nozzle to measure flow or light radiation. It would be appreciated that, the installation location of the sensor 104 is not only limited to the bottom of the container 102 but can be installed anywhere inside/on the body to determine the level of material.

In another embodiment, oil container 102 can include a display that can be configured to show various information such as calories consumed, anti-oxidant consumed, last oil usage, message/notification and cooking tip or advertisement which can be entered on cloud server 110. For example, if a user entered a cooking tip as “Try less cholesterol olive oil” on cloud server 110, the oil container display may be notified by same cooking tip for health benefit. In another example, if an oil company and/or distributor enter an advertisement message related with a new product on the cloud server 110, then the display 206 may be notified by same advertisement.

In an embodiment, the container 102 may be made a variety of materials. In some cases, the container 102 is a generally rigid material, such as stainless steel or a relatively rigid plastic, such as co polyester, high density polyethylene, polypropylene, were polyethylene terephthalate. In some cases the plastic may be free of Bisphenol-A.

FIG. 6 illustrates an exemplary flow diagram of the present system, in accordance with an embodiment of the present disclosure. In an aspect, the proposed methods may be described in general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

The order in which the methods are described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described proposed system.

At step 602, a plurality of sensors embedded in said container can sense at least a level of said object inside said container or properties associated with said object inside said container, in real time.

At step 604, one or more processors embedded in said container can retrieve in real time, at least said sensed level or said one or more sensed properties.

At step 606, one or more processors in real-time can determine a current level of said object inside said container, or one or more current properties associated with said object inside said container, based on said sensed level or said one or more sensed properties.

At step 608, one or more processors can transmit in real-time said retrieved sensed level or said retrieved one or more sensed properties to one or more devices located at remote location. The container can include an operable switch, preferably at a bottom of said container, to enable power supply from a pre-determined power source to said plurality of sensors and said one or more processors for operations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

### ADVANTAGES OF THE INVENTION

The present disclosure provides a system and method for monitoring level of material stored in small and large receptacles using Internet of Things (JOT) devices.

The present disclosure provides a system and method for collecting information associated with level of the material stored in receptacles, determining the level of the material based on collected information, and displaying information associated with the level the material.

The present disclosure provides a system and method for collecting information associated with level of the material in receptacles and transmitting the collecting information to remotely located devices and/or cloud server for remote monitoring.

The present disclosure provides a system and method for collecting information associated with level of the material, compute usage of the material based on the level determined, and representing the usage in user friendly and user understandable manner on a display of a user device.

We claim:

1. A container to monitor a predefined level or to determine the density or viscosity of a medium associated with an object under measurement in said container, said container comprising:
a plurality of sensors adapted to sense, in real-time, at least a level of said object inside said container or properties associated with said object inside said container; and
one or more processors adapted to:
retrieve, in real-time, at least said sensed level or said one or more sensed properties;
determine, in real-time, based on said sensed level or said one or more sensed properties, a current level of said object inside said container, or one or more current properties associated with said object inside said container.

2. The container as claimed in claim 1, wherein said container comprises a transceiver, communicably coupled to said one or more processors, wherein said one or more processors causes the transceiver to transmit said retrieved sensed level or said retrieved one or more sensed properties to one or more devices located at remote location.

3. The container as claimed in claim 1, wherein said container comprises a Global System for Mobile communications (GSM) system, communicably coupled to said one or more processors, wherein said one or more processors causes the GSM system to transmit said retrieved sensed level or said retrieved one or more sensed properties to one or more devices located at remote location.

4. The container as claimed in claim 2 and claim 3, wherein said retrieved sensed level or said retrieved one or more sensed properties are analyzed to generate a report associated with at least one pre-configured parameter of said object inside said container, wherein said report is an visual representation of said at least one pre-configured parameter.

5. The container as claimed in claim 1, wherein said container comprises an operable switch, preferably at a bottom of said container, to enable power supply from a pre-determined power source to said plurality of sensors and said one or more processors for operations.

6. The container as claimed in claim 1, wherein said container comprises a display communicably coupled to said one or more processors, wherein said one or more processors causes the display to indicate, based on said sensed level or said one or more sensed properties at least a current level of said object inside said container, one or more properties associated with said object inside said container, changes in level of said object inside said container, wherein said one or more properties are indicated on one or more user configurable screens.

7. The container as claimed in claim 1, wherein said container comprises a plurality of indicators communicably coupled to said one or more processors, wherein said one or more processors causes at least one indicator selected from said plurality of indicators to indicate, based on said sensed level or said one or more sensed properties at least a current level of said object inside said container, one or more properties associated with said object inside said container, changes in level of said object inside said container.

8. The container as claimed in claim 1, wherein said plurality of sensors are selected from any or any combination of a pressure sensor, a strain gauge (weight gauge) sensor, a level sensor, an electronic sensor, an ultrasonic liquid-level sensor, a temperature sensor, a viscosity sensor, a density sensor, an multi-axis accelerometer, and a multivariable sensor.

9. The container as claimed in claim 1, wherein said container is a container in which said object is packaged or a container in which a packaged object is poured before usage.

10. The container as claimed in claim 1, wherein said plurality of sensors comprises:
one or more pressure sensors configured to measure, in real-time, a pressure inside said container, and communicate the measured pressure to said one or more processors to determine a height of the object in said container is proportionate to the measured pressure; or
one or more weight gauge sensors configured to measure, in real-time, a volume inside said container, and communicate the measured pressure to said one or more processors to determine a quantity of the object currently present in said container.

11. A method for monitoring a predefined level or for determining the density or viscosity of a medium associated with an object under measurement in a container, said container comprising:
sensing, at a plurality of sensors embedded in said container, in real-time, at least a level of said object inside said container or properties associated with said object inside said container; and
retrieving, at one or more processors embedded in said container, in real-time, at least said sensed level or said one or more sensed properties;
determining, at said one or more processors in real-time, based on said sensed level or said one or more sensed properties, a current level of said object inside said container, or one or more current properties associated with said object inside said container; and
transmitting, by said one or more processors, in real-time said retrieved sensed level or said retrieved one or more sensed properties to one or more devices located at remote location, wherein said container comprises an operable switch, preferably at a bottom of said container, to enable power supply from a pre-determined power source to said plurality of sensors and said one or more processors for operations.
